(19) United States
(12) Patent Application Publication
(10) Pub. No.: US 2026/0310866 A1
(43) Pub. Date: Oct. 8, 2026

(54) METHOD AND SYSTEM FOR EXPLORING COMPLEX MEGA CELLS IN INTEGRATED CIRCUIT

(71) Applicant: TAIWAN SEMICONDUCTOR MANUFACTURING COMPANY LTD., HSINCHU (TW)

(72) Inventors: CHIH-LIN CHEN, KAOHSIUNG CITY (TW); CHUNG-SHENG YUAN, HSINCHU CITY (TW)

(21) Appl. No.: 19/097,893

(22) Filed: Apr. 2, 2025

(51) Int. Cl. G06F 30/323; G06F 30/3315; G06F 111/20; G06F 119/12

(52) U.S. Cl. CPC G06F 30/323; G06F 30/3315; G06F 2111/20; G06F 2119/12

(57) ABSTRACT

The present disclosure provides a method which includes the following steps: obtaining, by a processor, a first netlist of an integrated circuit (IC) design; traversing, by the processor, a plurality of cell-to-cell connections within the first netlist; creating, by the processor, a plurality of candidate complex mega cells from a plurality of cell-to-cell results selected from the cell-to-cell connections; updating, by the processor, a cell library with the candidate complex mega cells; re-synthesize, by the processor, the IC design using the updated cell library to obtain a second netlist of the IC design; and performing, by the processor, an automatic placement-and-routing (APR) process on the second netlist using layout diagrams of the candidate complex mega cells.

### BACKGROUND

The current trend in miniaturizing integrated circuits (ICs) has led to the development of smaller, more efficient devices with increased functionality and higher operating speeds. This miniaturization process has also brought about more stringent design and manufacturing requirements, as well as reliability challenges. Electronic design automation (EDA) tools are utilized to create, optimize, and validate standard cell layout designs for integrated circuits, ensuring that they meet both design and manufacturing specifications.

### BRIEF DESCRIPTION OF THE DRAWINGS

Aspects of the present disclosure are best understood from the following detailed description when read with the accompanying figures. It is emphasized that, in accordance with standard practice in the industry, various features are not drawn to scale. In fact, the dimensions of the various features can be arbitrarily increased or reduced for clarity of discussion.

FIG. 1 is a block diagram of an IC design system 100 in accordance with some embodiments.

FIG. 2 is a flowchart of a method for exploring complex mega cells in an integrated circuit in accordance with some embodiments of the present disclosure.

FIGS. 3A-3K are diagrams illustrating various cell-to-cell connections in an IC design in accordance with some embodiments of the present disclosure.

FIG. 4 is a diagram illustrating a relationship table recording a number of occurrences of each cell-to-cell connections in accordance with some embodiments of the present disclosure.

FIGS. 5A-5I are schematic diagrams of candidate complex mega cells being traversed in accordance with some embodiments of the present disclosure.

FIG. 6 is a diagram illustrating converting a combination of logic gates to a single complex mega cell in accordance with some embodiments of the present disclosure.

FIG. 7 is a flowchart of operation 210 in accordance with the embodiment of FIG. 2.

FIG. 8 is a block diagram of an IC manufacturing system 800, and an IC manufacturing flow associated therewith, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features can be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Further, it will be understood that when an element is referred to as being “connected to” or “coupled to” another element, it can be directly connected to or coupled to the other element, or intervening elements can be present.

Embodiments, or examples, illustrated in the drawings are disclosed as follows using specific language. It will nevertheless be understood that the embodiments and examples are not intended to be limiting. Any alterations or modifications in the disclosed embodiments, and any further applications of the principles disclosed in this document are contemplated as would normally occur to one of ordinary skill in the pertinent art.

Further, it is understood that several processing steps and/or features of a device can be only briefly described. Also, additional processing steps and/or features can be added, and certain of the following processing steps and/or features can be removed or changed while still implementing the claims. Thus, it is understood that the following descriptions represent examples only, and are not intended to suggest that one or more steps or features are required.

In addition, the present disclosure may repeat reference numerals and/or letters in the various examples. This repetition is for the purpose of simplicity and clarity and does not in itself dictate a relationship between the various embodiments and/or configurations discussed.

As used herein, the term "technology node" (or "wafer node", "process node", "process technology node", or "node") refers to a parameter in a specific semiconductor manufacturing process and its design rules. For example, the technology node used herein may be defined by a minimum gate width of a chip. A smaller technology node corresponds to a smaller feature size, which in turn corresponds to smaller transistors.

In integrated circuit (IC) design, a variety of functions are integrated into one chip, and an application specific integrated circuit (ASIC) or system on a chip (SOC) cell based design is often used. In this approach, a library of known functions is provided, and after the functional design of the device is specified by choosing and connecting these standard functions, and proper operation of the resulting circuit is verified using electronic design automation (EDA) tools, the library elements are mapped on to predefined layout cells, which contain prefigured elements such as transistors. The cells are chosen with the particular semiconductor process nodes and parameters in mind and create a process-parameterized physical representation of the design. The design flow continues from that point by performing placement and routing of the local and global connections needed to form a layout of the completed design using the standard cells.

After the layout is completed, various analysis procedure are performed and the layout is verified to check whether the layout violates any of the various constraints or rules. For example, design rule check (DRC), layout versus schematic (LVS) and electric rule check (ERC) are performed. The DRC is a process of checking whether the layout is successfully completed with a physical measure space according to the design rule, and the LVS is a process of checking whether the layout meets a corresponding circuit diagram. In addition, the ERC is a process of for checking whether devices and wires/nets are electrically well connected therebetween. After design rule checks, design rule verification, timing analysis, critical path analysis, static and dynamic power analysis, and final modifications to the design, a tape out process is performed to produce photomask generation data. This photomask generation (PG) data is then used to create the optical masks used to fabricate the semiconductor device in a photolithographic process at a wafer fabrication facility (FAB). In the tape out process, the database file of the IC is used to make various layers of masks for integrated circuit manufacturing. In some embodiments, the database file is a Graphic Database System (GDS) file (e.g., a GDS file or a GDSII file). Furthermore, the GDS file is the industry's standard format for transfer of IC layout data between design tools of different vendors.

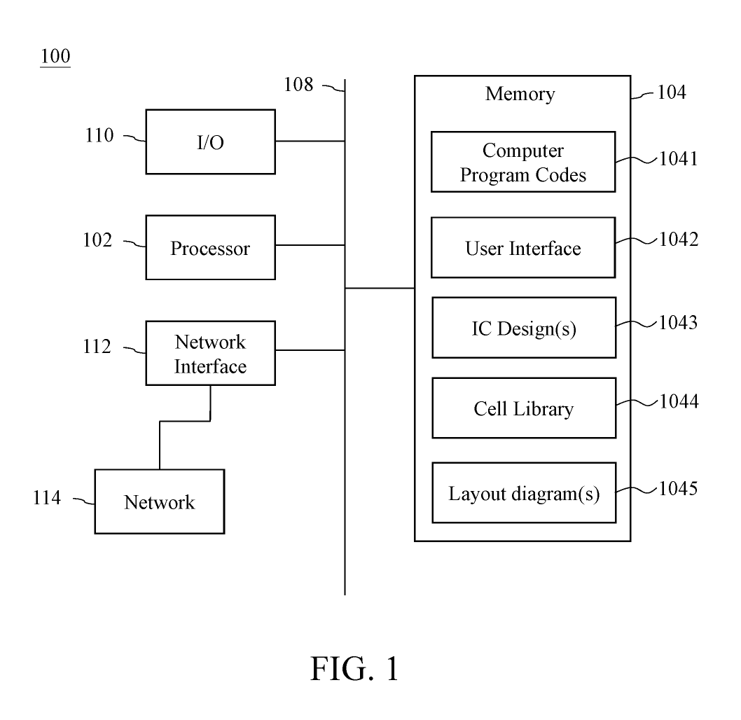

FIG. 1 is a block diagram of an IC design system 100 in accordance with some embodiments. Methods described herein for designing IC layout diagrams and adaptively generating power delivery networks in accordance with one or more embodiments are implementable, for example, using IC design system 100, in accordance with some embodiments.

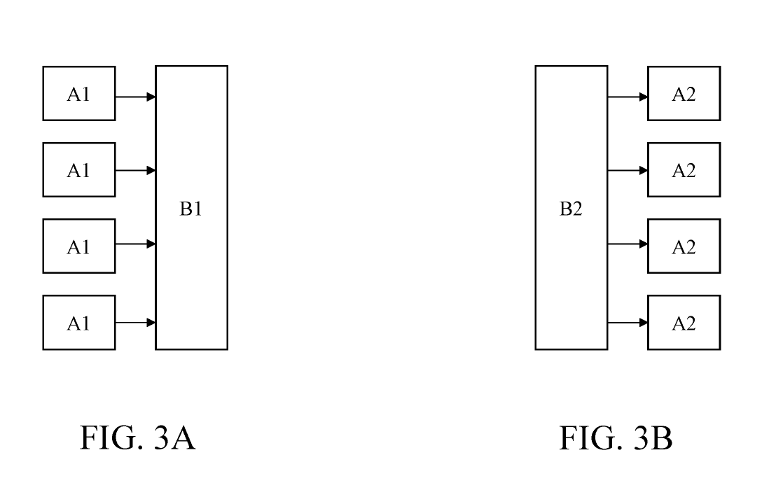

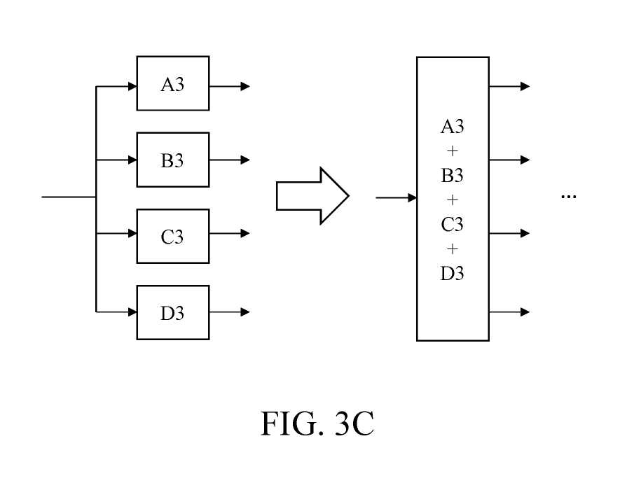

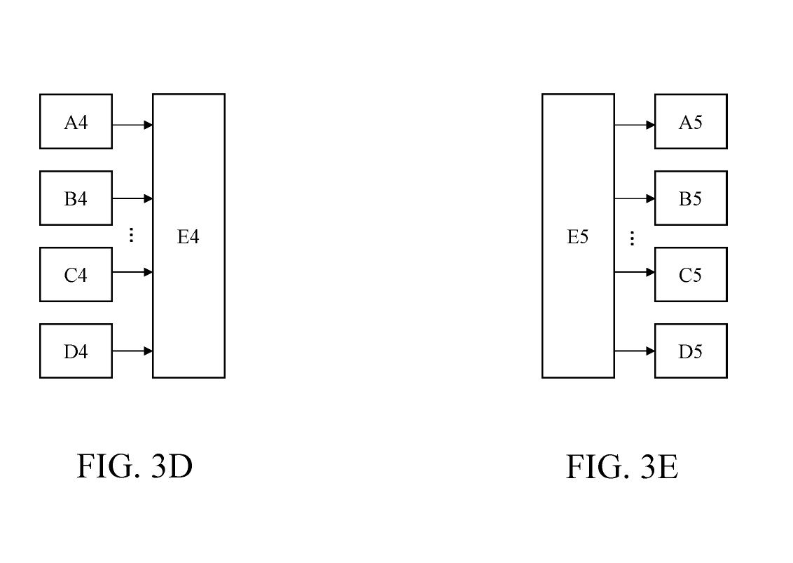

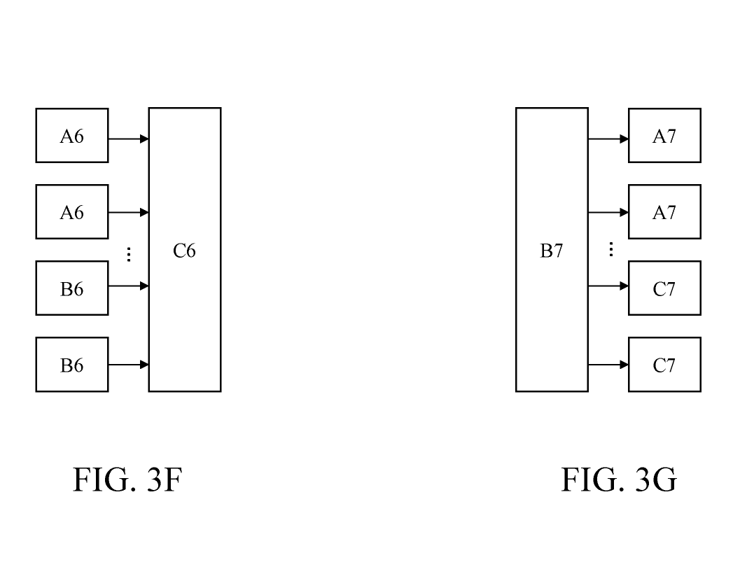

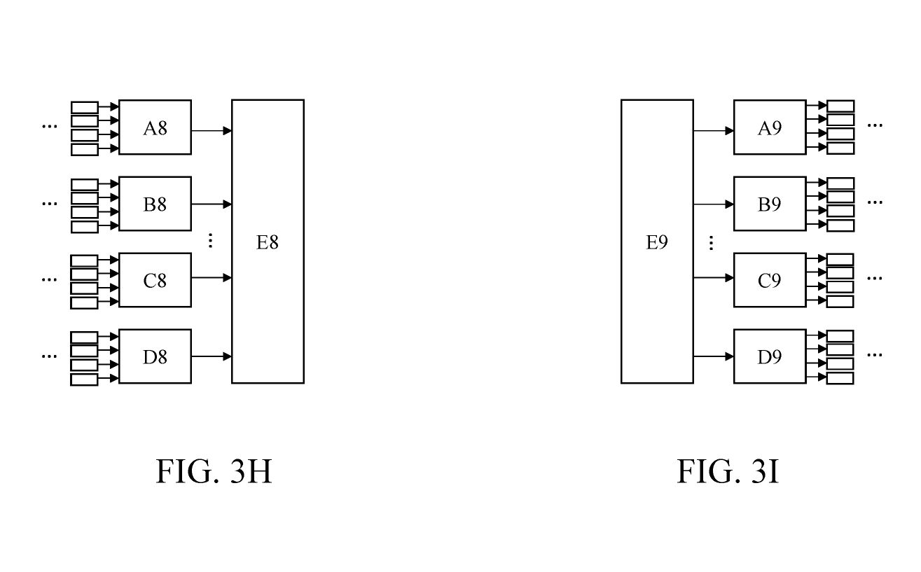

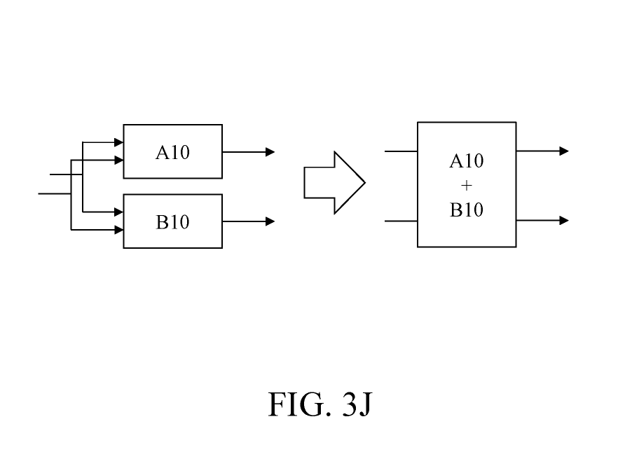

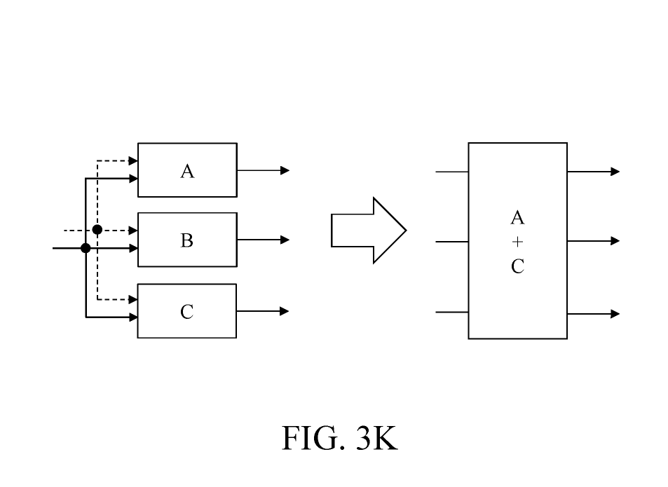

In some embodiments, IC design system 100 is a general purpose computing device including a hardware processor 102 and memory 104. Memory 104 is a non-transitory, computer-readable storage medium. Memory 104, amongst other things, is encoded with, i.e., stores, computer program codes 1041, i.e., a set of executable instructions. Execution of computer program codes 1041 by hardware processor 102 represents (at least in part) an EDA tool which implements a portion or all of a method or flow shown in FIGS. 3-8 described later (hereinafter, the noted processes and/or methods).

Processor 102 is electrically coupled to memory 104 via bus 108. Processor 102 is also electrically coupled to an I/O interface 110 through bus 108. Network interface 112 is also electrically connected to processor 102 through bus 108. Network interface 112 is connected to a network 114, so that processor 102 and memory 104 are capable of connecting to external elements via network 114. Processor 102 is configured to execute computer program codes 1041 encoded in memory 104 in order to cause IC design system 100 to be usable for performing a portion or all of the noted processes and/or methods. In one or more embodiments, processor 102 is a central processing unit (CPU), a multi-processor, a distributed processing system, an application specific integrated circuit (ASIC), and/or a suitable processing unit, but the present disclosure is not limited thereto.

In one or more embodiments, memory 104 is an electronic, magnetic, optical, electromagnetic, infrared, and/or a semiconductor system (or apparatus or device). For example, memory 104 may be or include a non-volatile memory such as a semiconductor or solid-state memory, a hard disk drive (HDD), a magnetic tape, a removable computer diskette, a random access memory (RAM), a read-only memory (ROM), a rigid magnetic disk, an optical disk, SD memory card, memory sticks, ferroelectric random access memory (FeRAM), resistive random access memory (RRAM), etc., but the present disclosure is not limited thereto. In one or more embodiments using optical disks, memory 104 includes a compact disk-read only memory (CD-ROM), a compact disk-read/write (CD-R/W), and/or a digital video disc (DVD).

In one or more embodiments, memory 104 stores computer program codes 1041 configured to cause IC design system 100 (where such execution represents (at least in part) the EDA tool) to be usable for performing a portion or all of the noted processes and/or methods. In one or more embodiments, memory 104 also stores information which facilitates performing a portion or all of the noted processes and/or methods.

IC design system 100 includes I/O interface 110. I/O interface 110 is coupled to external circuitry. In one or more embodiments, I/O interface 110 includes a keyboard, keypad, mouse, trackball, trackpad, touchscreen, and/or cursor direction keys for communicating information and commands to processor 102.

In some embodiments, IC design system 100 also includes network interface 112 coupled to processor 102. Network interface 112 allows IC design system 100 to communicate with network 114, to which one or more other computer systems are connected. In some embodiments, network interface 112 includes wireless network interfaces and/or wired network interface. The wireless network interface may include Wi-Fi (802.11), Global System for Mobile Communications (GSM), Enhanced Data rates for GSM Evolution (EDGE), Wideband Code Division Multiple Access (WCDMA), Time Division-Synchronous Code Division Multiple Access (TD-SCDMA), Long Term Evolution (LTE), 4-th Generation (4G), 5-th Generation (5G), 6-th Generation (6G), ultra-wideband (UWB), infrared (IR) protocols, near field communication (NFC) protocols, Wibree, Bluetooth protocols, wireless Universal Serial Bus (USB) protocols, etc. The wired network interfaces may include Ethernet, Universal Serial Bus (USB), Inter Integrated Circuit (I2C), Serial Peripheral Interface (SPI), etc., but the present disclosure is not limited thereto. In one or more embodiments, a portion or all of noted processes and/or methods, is implemented in two or more IC design systems 100.

In some embodiments, IC design system 100 is configured to receive information through I/O interface 110. The information received through I/O interface 110 includes one or more of instructions, data, design rules, libraries of standard cells, and/or other parameters for processing by processor 102. The information is transferred to processor 102 via bus 108. IC design system 100 is configured to receive information related to a user interface through I/O interface 110. The information is stored in memory 104 as user interface (UI) 1042. In some embodiments, memory 104 is configured to store one or more IC designs 1043, such as hardware description language (HDL) files and netlists of one or more ICs.

Cell library 1044 may include one or more cell libraries each storing schematics of a plurality of cells that can be used in a pre-layout simulation process. For example, a cell may refer to a standard cell, an analog cell, a memory cell (e.g., SRAM bit cell), an input/output (I/O) cell, or the like. In some embodiments, each standard cell may be a macro or a macro cell including one or more transistors. Examples of a macro including one logic gate can be an NOT, AND, OR, NAND, NOR, XOR gate, etc. In some embodiments, each cell in the cell library includes a plurality of logic gates. Examples of a macro including plural logic gates or a CMOS complex gate can be a 2-bit full adder, a D flip-flop, a latch, a buffer, and-or-invert gate (AOI), or-and-inverter gate (OAI), etc. In some embodiments, a mega cell may refer to a macro in the cell library 1044, while a complex mega cell (or compound mega cell) may refer to a combination of one or more mega cells and/or logic gates. In some embodiments, a complex mega cell may refer to a combination of two or more standard cells within the cell library 1044.

In some embodiments, memory 104 is further configured to store one or more layout diagrams 1045 corresponding to the one or more IC designs 1043. For example, when the EDA tool (e.g., an automatic placement-and-routing (APR) tool) performs an APR process on the netlist of a specific IC design, the layout diagram corresponding to the netlist of the specific IC design is generated by the EDA tool, which is stored in memory 104.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a portion or all of the noted processes and/or methods is implemented as a software application that is used by IC design system 100.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

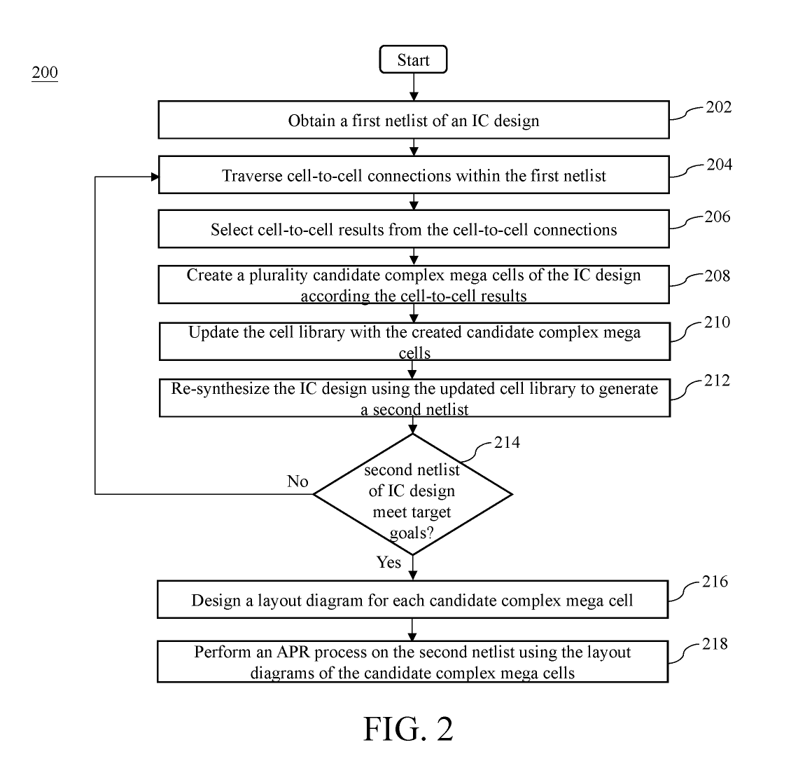

FIG. 2 is a flowchart of a method for exploring complex mega cells in an integrated circuit in accordance with some embodiments of the present disclosure. FIGS. 3A-3K are diagrams illustrating various cell-to-cell connections in an IC design in accordance with some embodiments of the present disclosure.

In some embodiments, method 200, which includes operations 202 to 218, may be employed to explore complex mega cells in an IC design, and integrate the explored complex mega cells into the cell library for synthesis. Additionally, the layout diagrams of the explored complex mega cells can be specifically designed or drawn with a reduced area compared to the equivalent circuit implemented using basic logic gates or standard cells.

At operation 202, a first netlist of an IC design is obtained. For example, the IC design may be a digital circuit of various types, and the HDL file of the IC design is synthesized (e.g., using a synthesis tool, such as Design Compiler®, Virtuoso®, etc.) using a predetermined cell library to obtain the netlist of the IC design.

At operation 204, cell-to-cell connections (e.g., connections between cells) within the first netlist are traversed. For example, the first netlist provides a gate-level description of the IC design, indicating that logic gates and standard cells from the cell library 1044 are included in the netlist to implement the IC design. In some embodiments, operation 204 can be performed once or repeatedly to explore possible combinations of connections between the logic gates and standard cells in two or more stages, the details of which are described with reference to FIGS. 3A-3K. In some embodiments, when operation 204 is repeatedly performed, the stages of the candidate complex mega cells being traversed could increase with the number of iterations of operation 204 until a predetermined number of iterations has reached.

In various non-limiting examples, the two-stage cell-to-cell connections may include a plurality of input cells plus a subsequent cell, an input cell with a plurality of subsequent cells, a plurality of cells arranged in parallel, etc. It should be noted that the standard cells in the cell library 1044 have respective cell names, indicating their function and driving strength. For example, cell names “INV”, “NR”, “ND”, “AO”, “OA” may represent an inverter, a NOR gate, a NAND gate, an and-or cell, an or-and cell, respectively. Additionally, a suffix appended to a specific cell name may indicate the driving strength of the specific cell. A suffix of “D1” to a specific cell name indicates that the specific cell has a unit driving strength, a suffix of “D2” to the specific cell name indicates substantially twice driving strength compared to the specific cell name with a suffix of “D1”, and so forth.

In some embodiments, FIG. 3A illustrates a two-stage cell-to-cell connection of four input cells A1 followed by a cell B1 with four inputs. The four input cells A1 can be four distinct standard cells in the cell library 1044 of the same type with one or more inputs and one output, while cell B1 can be any one of the standard cells in the cell library 1044 with four inputs and one or more outputs. FIG. 3B illustrates another two-stage cell-to-cell connection of an input cell B2 followed by four cells A2. The input cell B2 can be any one of the standard cells in the cell library 1044 with one or more inputs and four outputs, while each cell A2 may be a standard cell with one input and one or more outputs.

In some embodiments, FIG. 3C illustrates a two-stage cell-to-cell connection of four cells A3 to D3 arranged in parallel. This arrangement can be changed to a complex mega cell performing a function of A3+B3+C3+D3 using one input and generating four outputs. The parallel arrangement shown in FIG. 3C is for purposes of description, and there may be any other similar parallel arrangements of other types of cells.

In some embodiments, FIG. 3D illustrates yet another two-stage cell-to-cell connection of four input cells A4 to D4 followed by a cell E4 with four inputs. The four input cells A4 to D4 can be four standard cells in the cell library 1044 of different types each with one or more inputs and one output, while cell E4 can be any one of the standard cells in the cell library 1044 with four inputs and one or more outputs. FIG. 3E illustrates yet another two-stage cell-to-cell connection of an input cell E5 followed by four cells A5 to D5. The input cell E5 can be any one of the standard cells in the cell library 1044 with one or more inputs and four outputs, while the cells A5 to D5 may be different standard cells each with one input and one or more outputs.

In some embodiments, FIG. 3F illustrates still another two-stage cell-to-cell connection of two input cells A6 and two input cells B6 followed by a cell C6 with four inputs. The four input cells A6 and B6 can be two standard cells in the cell library 1044 of different types each with one or more inputs and one output, while cell C6 can be any one of the standard cells in the cell library 1044 with four inputs and one or more outputs. FIG. 3G illustrates still another two-stage cell-to-cell connection of an input cell B7 followed by two cells A7 and two cells C7. The input cell B7 can be any one of the standard cells in the cell library 1044 with one or more inputs and four outputs, while the cells A7 and C7 may be different standard cells each with one input and one or more outputs.

In some embodiments, the cell-to-cell connections traversed in operation 204 can include more than two stages. For example, referring to FIG. 3H, cells A8 to D8 are followed by cell E8, the cells A8 to D8 may be different cells each with four inputs and one output, and they receive respective input signals from the previous stage. Cell E8 may be one of the standard cells in the cell library 1044 with four inputs and one or more outputs. Additionally, referring to FIG. 3I, cell E9 is followed by cells A9 to D9, each being followed by respective four cells. For example, cell E9 may be one or the standard cell in the cell library 1044 with one or more inputs and four outputs, while cells A9 to D9 are different cells each with one input and four outputs.

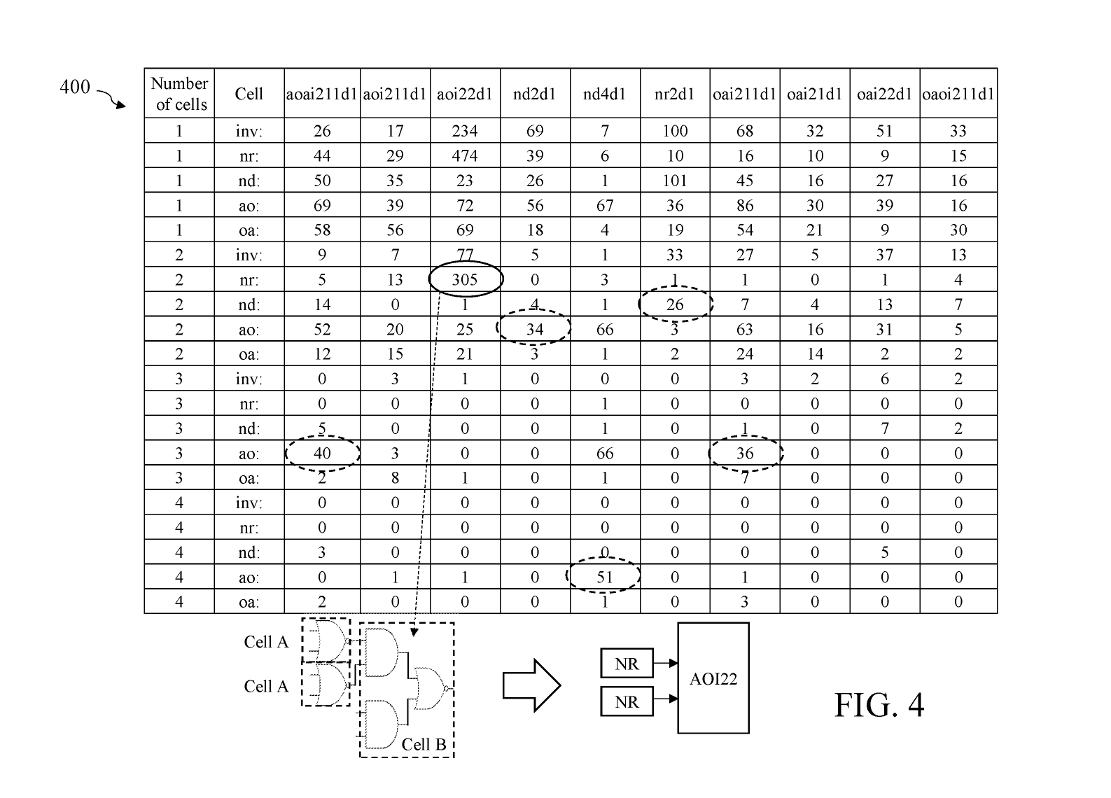

Referring back to FIG. 2, at operation 206, a plurality of cell-to-cell results are selected from the cell-to-cell connections. In some embodiments, a relationship table recording the number of occurrences of each two-stage cell-to-cell connections can be built by the EDA tool performed by the processor 102. Each two-stage cell-to-cell connection includes a first stage and a second stage. For simplicity, two-stage cell-to-cell connections and their respective number of occurrences within an X4 instance of the IC design are illustrated in table 400 in FIG. 4. For example, referring to table 400, the first column shows the number of cells of the input cell(s) (e.g., cell A) in the first stage, while the second column shows the cell name of the input cell(s) in the first stage. Additionally, the first row of table 400 shows the cell name (e.g., cell B) in the second stage.

For example, the cell names “aoai211d1” may denote to an and-or-and-invert gate with two inputs, one middle input, and an additional input. The cell name “aoi211d1” may denote to an and-or-invert gate with two inputs, one middle input, and an additional input. The cell name “aoi22d1” may denote to an and-or-invert cell with two inputs and two middle inputs. Additionally, the cell names “nd2d1”, “nd4d1”, and “nr2d1” may denote to a two-input NAND gate, a four-input NAND gate, and a two-input NOR gate, respectively. Furthermore, the cell name “oai211d1” may denote to an or-and-invert gate with two inputs, one middle input, and an additional input. The cell name “oai21d1” may denote to an or-and-invert gate with two inputs and an additional input. The cell name “oai22d1” may denote to an or-and-invert gate with two inputs and two additional inputs. The cell name “oaoi211d1” may denote to an or-and-or-invert gate with two inputs, one middle input, and an additional input. It should be noted that the X4 instance could include more standard cells which are listed on table 400, and other instances in the IC design can include different standard cells.

For example, the number of occurrences of a two-stage cell-to-cell connection with two “and-or (ao)” gates followed by an and-or-and-invert (aoai211d1) gate is 52, and the number of occurrences of a two-stage cell-to-cell connection with two NOR gates followed by an and-or-and-inverter (aoi22d1) cell is 305, and so forth.

Specifically, a portion of the two-stage cell-to-cell connections listed on table 400 in FIG. 4 can be selected according to the number of occurrences and complexity of each two-stage cell-to-cell connection in table 400. For example, a specific cell in the second stage with more inputs can be considered more complex than that with fewer inputs. Accordingly, the two-stage cell-to-cell connections, which includes three or four input cells, in the lower portion of table 400 can be considered to have a higher complexity than those, which includes one or two inputs cells, in the upper portion of table 400. In addition, the cell-to-cell connections with more than two stages can also be considered to have a higher complexity than those with two stages.

Consequently, the EDA tool may assign a respective weight to each two-stage cell-to-cell connection according to its complexity, such as assigning a higher weight to a specific two-stage cell-to-cell connection with a higher complexity, and assigning a lower weight to a another specific two-stage cell-to-cell connection with a lower complexity. Subsequently, the EDA tool can calculate an overall score for each cell-to-cell connection by multiplying the number of occurrences with the respective weight. For example, when the EDA tool determines that the overall score for a specific cell-to-cell connection exceeds a predetermined threshold, the EDA tool may select the specific cell-to-cell connection as one of the cell-to-cell results, indicating that the specific cell-to-cell connection is a combination of a candidate complex mega cell. For purposes of description, the six combinations of the cell-to-cell connections are selected from table 400, as indicated by circles in FIG. 4, namely, three an-or gates (ao) followed by an an-or-and-invert gate (aoai211d1), two two-input NOR gates followed by an and-or-inverter gate (aoi22d1), two and-or gates followed by a two-input NAND gate (nd2d1), four and-or gates (ao) followed by a four-input NAND gate (nd4d1), two two-input NAND gates (nd) followed by a two-input NOR gate (nr2d1), and three and-or gates (ao) followed by an or-and-invert gate (oai211d1).

Taking the cell-to-cell connection of two two-input NOR gates followed by an and-or-inverter gate (aoi22d1) as an example, each two-input NOR gate (nr) can be denoted as Cell A, and the and-or-invert gate (aoi22d1) can be denoted as Cell B. Accordingly, the combination of two two-input NOR gates followed by an and-or-inverter gate (aoi22d1) can be expressed by two NR gates plus an AOI22 gate, as depicted in FIG. 4.

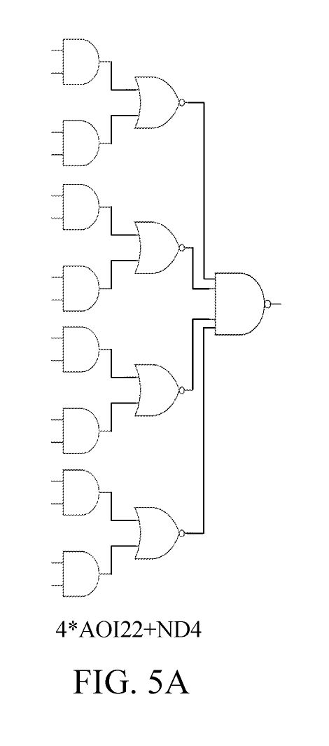

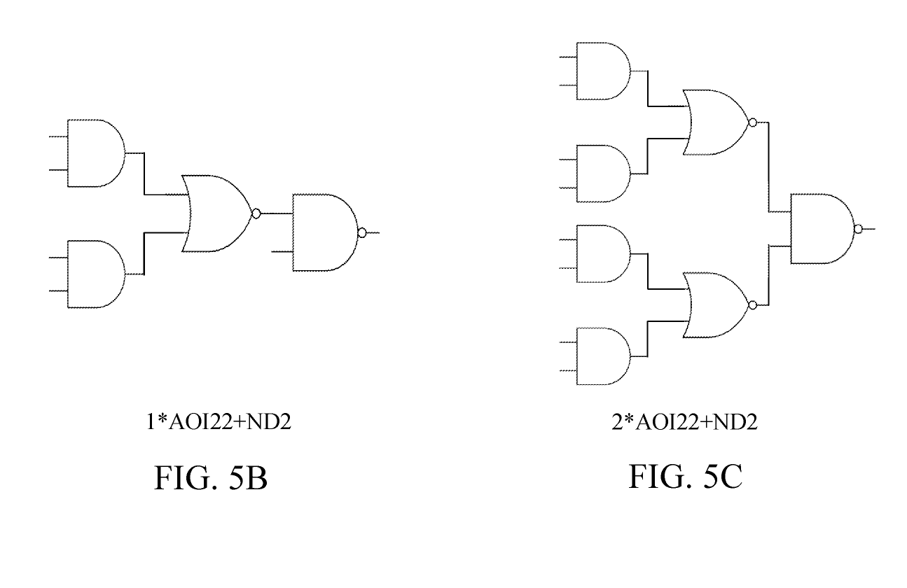

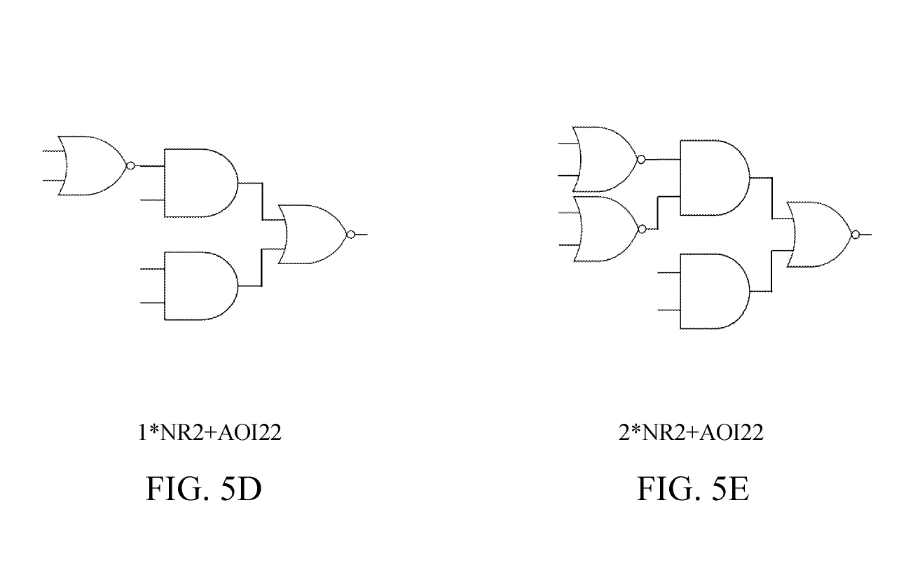

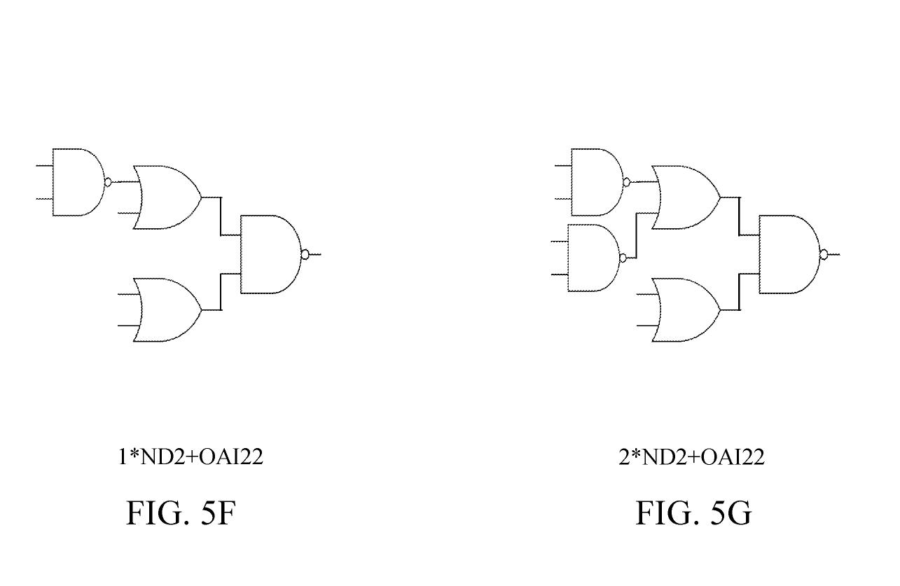

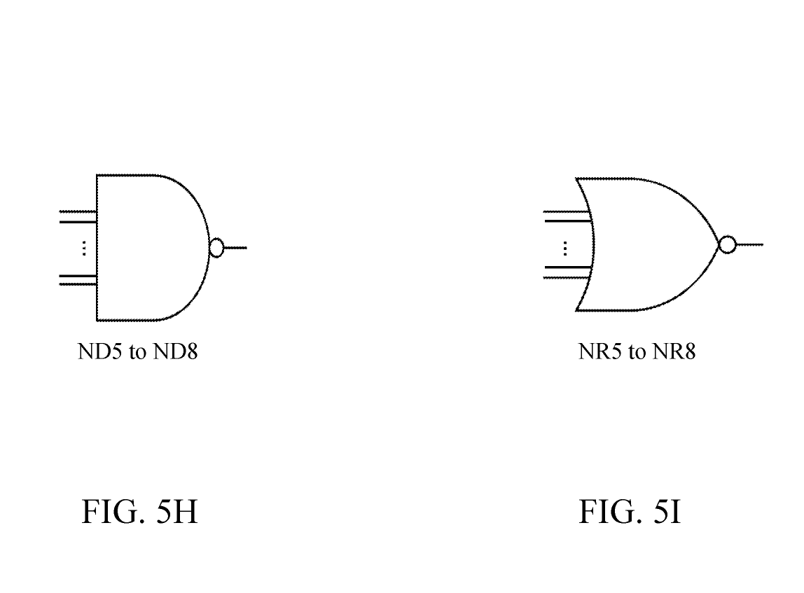

In some embodiments, the flow between operations 204 to 212 can be performed repeatedly, and every iteration of operations 204 to 212 may explore more new candidate complex mega cells. For simplicity, 15 candidate complex mega cells are traversed, including 4*AOI22+ND4, 1*AOI22+ND2, 2*AOI22+ND2, 1NR2+AOI22, 1*ND2+OAI22, 2*NR2+AOI22, 2*ND2+OAI22, ND5 to ND8, and NR5 to NR8, which are illustrated in FIGS. 5A-5I, respectively.

At operation 208, a plurality of candidate complex mega cells of the IC design are created according to the cell-to-cell results. In some embodiments, although the function of each candidate complex mega cell can be implemented using basic standard cells within the cell library 1044, however, each candidate complex mega cell, which may help to reduce the area of the IC design, do not exist in the original cell library 1044 since they are created using the analysis table 400 for the X4instance within the IC design.

At operation 210, the cell library 1044 is updated with the created candidate complex mega cells. In some embodiments, after the candidate complex mega cells are created, it should be confirmed whether the candidate complex mega cells will be used by the EDA synthesis tool. As such, it is necessary to incorporate the created candidate complex mega cells into the cell library 1044. Further details about operation 210 are described with reference to the embodiment of FIG. 3.

At operation 212, the IC design is re-synthesized using the updated cell library to generate a second netlist. In some embodiments, after the candidate complex mega cells are incorporated into the cell library 1044, the HDL file of the IC design can be re-synthesized by the synthesis tool using the updated cell library 1044 to generate an updated netlist, i.e., the second netlist, of the IC design. It should be noted that the synthesis EDA tool will optimize the IC design to meet the timing and power constraints first, and then try to reduce the area using different standard cells and the newly added complex mega cells in the cell library 1044.

At operation 214, it is determined whether the second netlist of the IC design meets target goals. When it is determined that the second netlist does not meet the target goals, the flow returns to operation 204. When it is determined that the second netlist meets the target goals, the flow proceeds to operation 216. In some embodiments, after synthesis, information about each instance within the second netlist can be reported, such as a number of ports, a number of nets, a number of cells, a number of combinational cells, a number of sequential cells, a number of buffers/inverters, a combinational area, a buffer/inverter area, a non-combinational area, and a total cell area. The information about each instance within the second netlist can be compared with that within the first netlist to check whether the number of combinational cells, combinational area, and total cell area are reduced using the second netlist. When the number of combinational cells, combinational area, and total cell area are reduced using the second netlist, it can be determined that the candidate complex mega cells are used in the second list, indicating that the target goals are met.

At operation 216, a layout diagram is designed for each candidate complex mega cell. In some embodiments, when a layout diagram of a specific candidate complex mega cell, which includes a plurality of basic logic gates (e.g., INV, AND, OR, OAI, AOI gates, or a combination thereof), are generated using the layout diagrams of the basic logic gates, the overall area of the layout diagram may be substantially equal to a total area of the layout areas of the basic logic gates. However, when the layout diagram of the specific candidate complex mega cell is particularly designed using one or more area reduction techniques, such as using a transistor-sharing or common-node principle (e.g., two adjacent transistors can share a common source/drain terminal), complementary logic, optimizing logic expressions, implementing series and parallel sharing, using pass transistor logic, or a combination thereof, the overall layout area of the specific candidate complex mega cell is smaller than the total area of the layout areas of the basic logic gates.

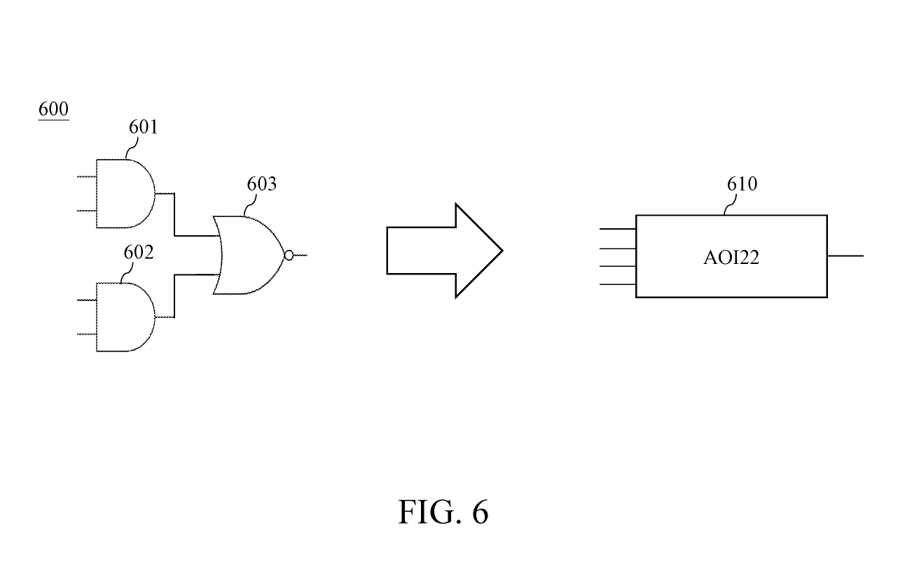

For example, as shown in FIG. 6, a cell-to-cell connection 600, which has a function of two two-input AND gates plus and a two-input NOR gate (e.g., 2*AN2+1*NR2), may have a total area of approximately 0.089μm² using separate AN2 and NR2 logic gates. When the cell-to-cell connection 600 is implemented using a single complex mega cell 610, the layout diagram of the complex mega cell 610 can be particularly designed using the aforementioned techniques. Consequently, the area of the complex mega cell 610 is approximately 0.041μm² which is a 54% area reduction compared to the total area of separate logic gates. It should be noted that the embodiment of FIG. 6 is a very simple example, and the percentage of area reduction may vary depending on the function, the number of logic gates, and complexity of the complex mega cell. Additionally, a reduced area of the complex mega cell can lead to a higher performance and a lower power consumption of the complex mega cell.

At operation 218, an automatic placement-and-routing (APR) process of the second netlist is performed using the layout diagrams of the candidate complex mega cells. In some embodiments, since the layout diagrams of the candidate complex mega cells within the cell library 1044 are particularly designed with a reduced area, the overall layout area of the IC design generated by the APR process performed by EDA tool using the second netlist is reduced as well. Therefore, the PPA (e.g., including performance, power, area) of the IC design can be enhanced.

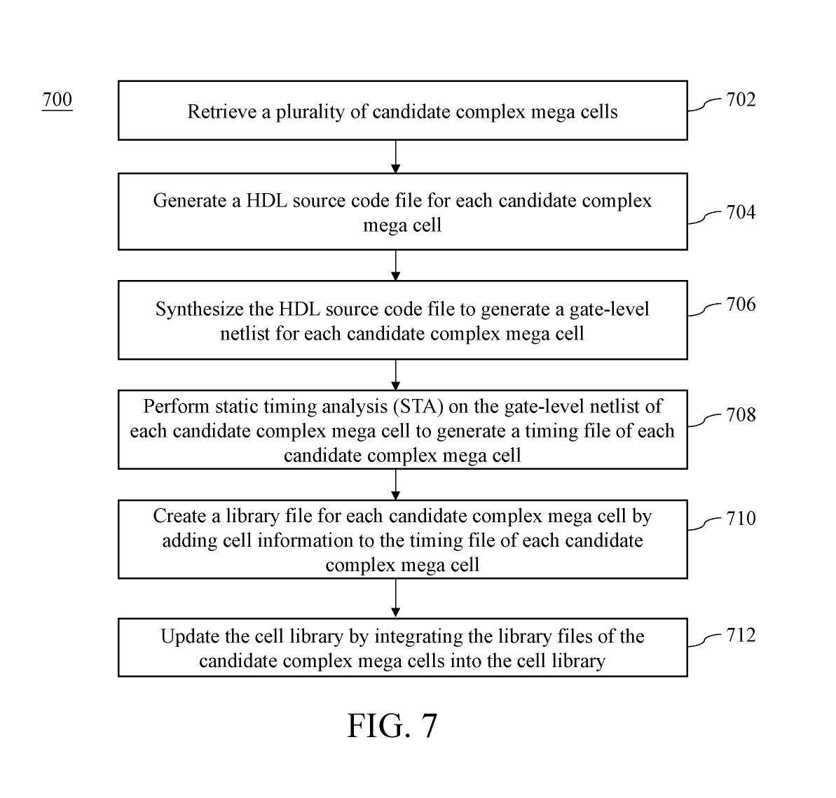

FIG. 7 is a flowchart of operation 210 in accordance with the embodiment of FIG. 2. Please refer to FIGS. 2 and 7 simultaneously.

At operation 702, a plurality of candidate complex mega cells are retrieved. In some embodiments, the candidate complex mega cells can be created according to the cell-to-cell results of the IC design at operation 208. The candidate complex mega cells can include two or more stage of cell-to-cell connections with overall scores exceeding the predetermined threshold, wherein the overall scores of each cell-to-cell connection can be computed by the EDA tool using the number of occurrences and complexity thereof.

At operation 704, a hardware description language (HDL) source code file of each candidate complex mega cell is generated. In some embodiments, upon the cell-to-cell results being selected from the cell-to-cell connections (e.g., as shown in FIG. 4), the EDA tool may automatically generate the HDL source code file associated with each candidate complex mega cell. For example, the generated HDL source code file may include hardware description about the corresponding candidate complex mega cell using basic logic gates, such as AND, OR, NOT gates.

At operation 706, the HDL source code file for each candidate complex mega cell is synthesized to generate a gate-level netlist for each candidate complex mega cell. In some embodiments, the gate-level netlist of each candidate complex mega cell may include hardware description about candidate complex mega cell using standard cells within the cell library 1044.

At operation 708, a static timing analysis (STA) is performed on the gate-level netlist of each candidate complex mega cell to generating a timing file of each candidate complex mega cell. In some embodiments, the timing file for each candidate complex mega cell may include delay information from any input pin to any output pin. In some embodiments, a unified power format (.upf) file can be added to the EDA tool to perform the STA, thereby adding power and ground (PG) information during the STA.

At operation 710, a library file of each candidate complex mega cell is created by adding cell information to the timing file of each candidate complex mega cell. In some embodiments, the timing file of each candidate complex mega cell is not qualified as a library file to be used in the cell library 1044 since it lacks cell information, such as an estimated area, cell footprint (e.g., cell name), PG information, and function information (e.g., the logic function) thereof. Accordingly, the EDA tool may add respective cell information to the timing file of each candidate complex mega cell to create a library file (e.g., in .lib format) of each candidate complex mega cell. In some embodiments, the library files of the candidate complex mega cell can be integrated into one library file.

At operation 712, the cell library 1044 is updated by integrating the library files of the candidate complex mega cells into the cell library 1044. In some embodiments, the EDA tool (e.g., Library Compiler) may convert the library files of the candidate complex mega cells, along with the original library file of the cell library 1044), to the cell library file (e.g., in .db format), thereby updating the cell library 1044. Accordingly, through operations 702 to 712 in FIG. 7, the cell library 1044 can be updated with the candidate complex mega cells for synthesis.

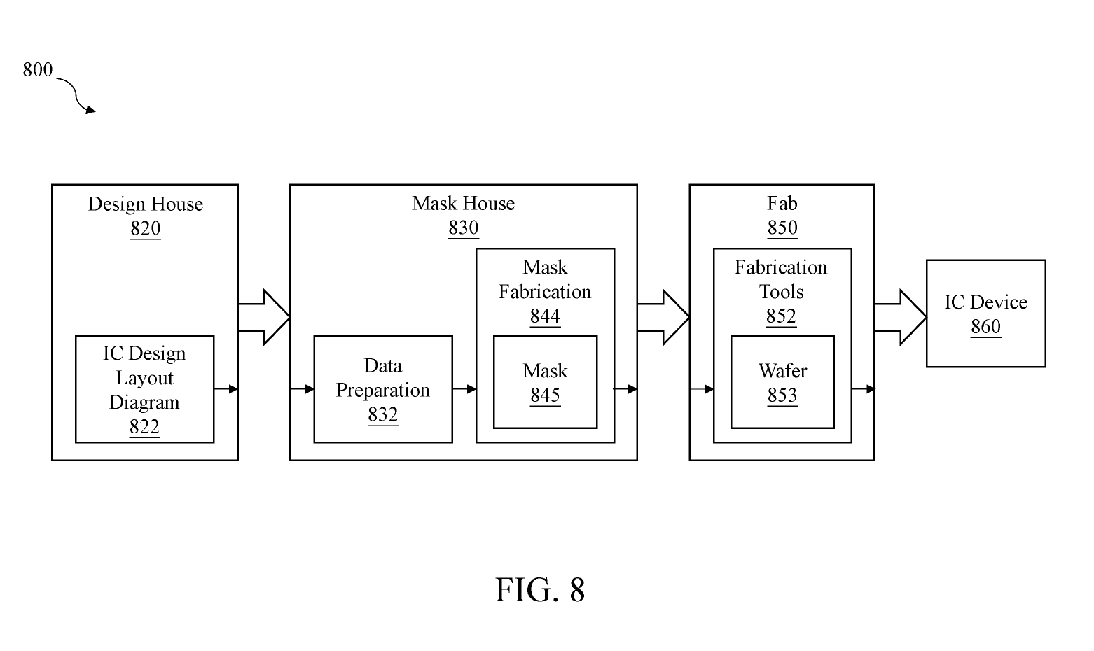

FIG. 8 is a block diagram of an IC manufacturing system 800, and an IC manufacturing flow associated therewith, in accordance with some embodiments. In some embodiments, based on an IC layout diagram, at least one of (A) one or more semiconductor masks or (B) at least one component in a layer of a semiconductor integrated circuit is fabricated using IC manufacturing system 800.

In FIG. 8, IC manufacturing system 800 includes entities, such as a design house 820, a mask house 830, and an IC manufacturer/fabricator (“fab”) 850, that interact with one another in the design, development, and manufacturing cycles and/or services related to manufacturing an IC device 860. The entities in IC manufacturing system 800 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of design house 820, mask house 830, and IC fab 850 is owned by a single larger company. In some embodiments, two or more of design house 820, mask house 830, and IC fab 850 coexist in a common facility and use common resources.

The design house (or design team) 820 generates an IC design layout diagram 822, which is obtained using schematics of electrical devices that utilize a smaller technology node migrated from a larger technology node, employing the methods described in the embodiments of FIGS. 1-8. IC design layout diagram 822 includes various geometrical patterns, such as the IC layout diagram discussed above. These geometrical patterns correspond to patterns of metal, oxide, or semiconductor layers that constitute the various components of IC device 860 to be fabricated. The various layers combine to form different IC features. For example, a portion of IC design layout diagram 822 includes various IC features, such as an active region, gate electrode, source and drain, metal lines or vias of an interlayer interconnection, and openings for bonding pads, to be formed in a semiconductor substrate (such as a silicon wafer) and various material layers disposed on the semiconductor substrate. Design house 820 implements an appropriate design procedure to form design layout diagram 822. The design procedure includes one or more of logic design, physical design, or place and route. IC design layout diagram 822 is presented in one or more data files containing information about the geometrical patterns. For example, IC design layout diagram 822 can be expressed in a GDSII file format or DFII file format.

Mask house 830 includes mask data preparation 832 and mask fabrication 844. Mask house 830 uses IC design layout diagram 822 to manufacture one or more masks 845 to be used for fabricating the various layers of IC device 860 according to IC design layout diagram 822. Mask house 830 performs mask data preparation 832, where IC design layout diagram 822 is translated into a representative data file (RDF). Mask data preparation 832 provides the RDF to mask fabrication 844. Mask fabrication 844 includes a mask writer. A mask writer converts the RDF to an image on a substrate, such as mask (reticle) 845 or a semiconductor wafer 853. The design layout diagram 822 is manipulated by mask data preparation 832 to comply with particular characteristics of the mask writer and/or requirements of IC fab 850. In FIG. 8, mask data preparation 832 and mask fabrication 844 are illustrated as separate elements. In some embodiments, mask data preparation 832 and mask fabrication 844 can be collectively referred to as mask data preparation.

In some embodiments, mask data preparation 832 includes optical proximity correction (OPC) which uses lithography enhancement techniques to compensate for image errors, such as those that can arise from diffraction, interference, other process effects and the like. OPC adjusts IC design layout diagram 822. In some embodiments, mask data preparation 832 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, mask data preparation 832 includes a mask rule checker (MRC) that checks the IC design layout diagram 822 that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout diagram 822 to compensate for limitations during mask fabrication 844, which may undo part of the modifications performed by OPC in order to meet mask creation rules.

In some embodiments, mask data preparation 832 includes lithography process checking (LPC) that simulates processing that will be implemented by IC fab 850 to fabricate IC device 860. LPC simulates this processing based on IC design layout diagram 822 to create a simulated manufactured device, such as IC device 860. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (“DOF”), mask error enhancement factor (“MEEF”), other suitable factors, and the like or combinations thereof. In some embodiments, after a simulated manufactured device has been created by LPC, if the simulated device is not close enough in shape to satisfy design rules, OPC and/or MRC are be repeated to further refine IC design layout diagram 822.

It should be understood that the above description of mask data preparation 832 has been simplified for the purposes of clarity. In some embodiments, mask data preparation 832 includes additional features such as a logic operation (LOP) to modify the IC design layout diagram 822 according to manufacturing rules. Additionally, the processes applied to IC design layout diagram 822 during mask data preparation 832 may be executed in a variety of different orders.

After mask data preparation 832 and during mask fabrication 844, a mask 845 or a group of masks 845 are fabricated based on the modified IC design layout diagram 822. In some embodiments, mask fabrication 844 includes performing one or more lithographic exposures based on IC design layout diagram 822. In some embodiments, an electron-beam (e-beam) or a mechanism of multiple e-beams is used to form a pattern on a mask (photomask or reticle) 845 based on the modified IC design layout diagram 822. Mask 845 can be formed in various technologies. In some embodiments, mask 845 is formed using binary technology. In some embodiments, a mask pattern includes opaque regions and transparent regions. A radiation beam, such as an ultraviolet (UV) or EUV beam, used to expose the image sensitive material layer (e.g., photoresist) which has been coated on a wafer, is blocked by the opaque region and transmits through the transparent regions. In one example, a binary mask version of mask 845 includes a transparent substrate (e.g., fused quartz) and an opaque material (e.g., chromium) coated in the opaque regions of the binary mask. In another example, mask 845 is formed using a phase shift technology. In a phase shift mask (PSM) version of mask 845, various features in the pattern formed on the phase shift mask are configured to have proper phase difference to enhance the resolution and imaging quality. In various examples, the phase shift mask can be attenuated PSM or alternating PSM. The mask(s) generated by mask fabrication 844 is used in a variety of processes. For example, such a mask(s) is used in an ion implantation process to form various doped regions in semiconductor wafer 853, in an etching process to form various etching regions in semiconductor wafer 853, and/or in other suitable processes.

IC fab 850 is an IC fabrication business that includes one or more manufacturing facilities for the fabrication of a variety of different IC products. In some embodiments, IC Fab 850 is a semiconductor foundry. For example, there may be a manufacturing facility for the front end fabrication of a plurality of IC products (front-end-of-line (FEOL) fabrication), while a second manufacturing facility may provide the back end fabrication for the interconnection and packaging of the IC products (back-end-of-line (BEOL) fabrication), and a third manufacturing facility may provide other services for the foundry business.

IC fab 850 includes wafer fabrication tools 852 configured to execute various manufacturing operations on semiconductor wafer 853 such that IC device 860 is fabricated in accordance with the mask(s), e.g., mask 845. In various embodiments, fabrication tools 852 include one or more of a wafer stepper, an ion implanter, a photoresist coater, a process chamber, e.g., a CVD chamber or LPCVD furnace, a CMP system, a plasma etch system, a wafer cleaning system, or other manufacturing equipment capable of performing one or more suitable manufacturing processes as discussed herein.

IC fab 850 uses mask(s) 845 fabricated by mask house 830 to fabricate IC device 860. Thus, IC fab 850 at least indirectly uses IC design layout diagram 822 to fabricate IC device 860. In some embodiments, semiconductor wafer 853 is fabricated by IC fab 850 using mask(s) 845 to form IC device 860. In some embodiments, the IC fabrication includes performing one or more lithographic exposures based at least indirectly on IC design layout diagram 822. Semiconductor wafer 853 includes a silicon substrate or other proper substrate having material layers formed thereon. Semiconductor wafer 853 further includes one or more of various doped regions, dielectric features, multilevel interconnects, and the like (formed at subsequent manufacturing steps).

An aspect of the present disclosure provides a method. The method includes the following steps: obtaining, by a processor, a first netlist of an integrated circuit (IC) design; traversing, by the processor, a plurality of cell-to-cell connections within the first netlist; creating, by the processor, a plurality of candidate complex mega cells from a plurality of cell-to-cell results selected from the cell-to-cell connections; updating, by the processor, a cell library with the candidate complex mega cells; re-synthesize, by the processor, the IC design using the updated cell library to obtain a second netlist of the IC design; and performing, by the processor, an automatic placement-and-routing (APR) process on the second netlist using layout diagrams of the candidate complex mega cells.

Another aspect of the present disclosure provides a system including a non-transitory computer-readable medium storing program instructions, and a processor operatively coupled to the non-transitory computer-readable medium. The program instructions, when executed by the processor, cause the processor to perform: traverse a plurality of cell-to-cell connections within a first netlist of an integrated circuit (IC) design; determine a plurality of candidate complex mega cells corresponding to a portion of the cell-to-cell connections meeting a predetermined criteria; update a cell library, which is used to generate the first netlist, with the candidate complex mega cells; synthesize the IC design using the updated cell library to obtain a second netlist of the IC design; in response to the second netlist meeting a plurality of target goals, design layout diagrams of the candidate complex mega cells using one or more area reducing techniques; and perform an automatic placement-and-routing (APR) process on the second netlist using layout diagrams of the candidate complex mega cells.

Yet another aspect of the present disclosure provides a method. The method includes the following steps: traversing, by a processor, a plurality of cell-to-cell connections within a first netlist of an integrated circuit (IC) design; determining, by the processor, a plurality of candidate complex mega cells corresponding to a portion of the cell-to-cell connections meeting a predetermined criteria; updating, by the processor, a cell library, which is used to generate the first netlist, with library files corresponding to the candidate complex mega cells; synthesize, by the processor, the IC design using the updated cell library to obtain a second netlist of the IC design; and performing, by the processor, an automatic placement-and-routing (APR) process on the second netlist using layout diagrams of the candidate complex mega cells.

The methods and features of the present disclosure have been sufficiently described in the provided examples and descriptions. It should be understood that any modifications or changes without departing from the spirit of the present disclosure are intended to be covered in the protection scope of the present disclosure.

Moreover, the scope of the present application is not intended to be limited to the particular embodiments of the process, machine, manufacture, and composition of matter, means, methods and steps described in the specification. As those skilled in the art will readily appreciate from the present disclosure, processes, machines, manufacture, composition of matter, means, methods or steps presently existing or later to be developed, that perform substantially the same function or achieve substantially the same result as the corresponding embodiments described herein, can be utilized according to the present disclosure.

Accordingly, the appended claims are intended to include within their scope processes, machines, manufacture, compositions of matter, means, methods or steps. In addition, each claim constitutes a separate embodiment, and the combination of various claims and embodiments are within the scope of the present disclosure.

What is claimed is:

1. A method, comprising:
obtaining, by a processor, a first netlist of an integrated circuit (IC) design;
traversing, by the processor, a plurality of cell-to-cell connections within the first netlist;
creating, by the processor, a plurality of candidate complex mega cells from a plurality of cell-to-cell results selected from the cell-to-cell connections;
updating, by the processor, a cell library with the candidate complex mega cells;
re-synthesize, by the processor, the IC design using the updated cell library to obtain a second netlist of the IC design; and
performing, by the processor, an automatic placement-and-routing (APR) process on the second netlist using layout diagrams of the candidate complex mega cells.

2. The method of claim 1, wherein the IC design is hardware description language (HDL) source code file, and the first netlist of the IC design comprises a HDL gate-level file.

3. The method of claim 2, wherein the cell-to-cell connections comprise two or more stages.

4. The method of claim 2, wherein each candidate complex mega cells include two or more standard cells within the cell library.

5. The method of claim 1, wherein the creating, by the processor, the plurality of candidate complex mega cells from the plurality of cell-to-cell results selected from the cell-to-cell connections comprises:
building a relationship table recording a number of occurrences of each cell-to-cell connection within the first netlist; and
selecting the cell-to-cell results from the cell-to-cell connections based on an overall score of each cell-to-cell connections.

6. The method of claim 5, wherein the selecting the cell-to-cell results from the cell-to-cell connections based on the overall score of each cell-to-cell connection comprises:
assigning a weight to each cell-to-cell connection according to a complexity thereof;
calculating the overall score of each cell-to-cell connection by multiplying the number of occurrences and the complexity thereof; and
selecting the cell-to-cell connections, which have the overall scores exceeding a predetermined threshold, as the cell-to-cell results.

7. The method of claim 1, further comprising:
in response to the second netlist of the IC design failing to meet target goals, traversing cell-to-cell connection within the updated netlist.

8. The method of claim 7, wherein the target goals comprises a number of combinational cells, an area of the combination cells, and a total cell area within the updated netlist, which are smaller than those in the netlist.

9. The method of claim 8, further comprising:
designing the layout diagram of each candidate complex mega cell using a transistor-sharing or common-node principle, complementary logic, logic expression optimization, implementing series and parallel sharing, pass transistor logic, or a combination thereof.

10. The method of claim 1, wherein the updating, by the processor, the cell library with the candidate complex mega cells comprises:
generating a hardware description language (HDL) source code file of each candidate complex mega cell;
synthesize the HDL source code file to generate a gate-level netlist of each candidate complex mega cell; and
performing static timing analysis (STA) on the gate-level netlist of each candidate complex mega cell to generate a timing file of each candidate complex mega cell.

11. The method of claim 10, wherein the updating, by the processor, the cell library with the candidate complex mega cells further comprises:
creating a library file for each candidate complex mega cell by adding cell information to the timing file of each candidate complex mega cell; and
updating the cell library by integrating the library files of the candidate complex mega cells into the cell library.

12. The method of claim 11, wherein the cell information comprises an estimated area, a cell footprint, power and ground (PG) information, and function information for each candidate complex mega cell.

13. The method of claim 12, wherein a unified power format (UPF) file recording the PG information is used while performing the STA on the gate-level netlist.

14. A system comprising a non-transitory computer-readable medium storing program instructions; and a processor operatively coupled to the non-transitory computer-readable medium, wherein the program instructions, when executed by the processor, cause the processor to perform:
traverse a plurality of cell-to-cell connections within a first netlist of an integrated circuit (IC) design;
determine a plurality of candidate complex mega cells corresponding to a portion of the cell-to-cell connections meeting a predetermined criteria;
update a cell library, which is used to generate the first netlist, with the candidate complex mega cells;
synthesize the IC design using the updated cell library to obtain a second netlist of the IC design;
in response to the second netlist meeting a plurality of target goals, design layout diagrams of the candidate complex mega cells using one or more area reducing techniques; and
perform an automatic placement-and-routing (APR) process on the second netlist using layout diagrams of the candidate complex mega cells.

15. The system of claim 14, wherein the determining the plurality of candidate complex mega cells corresponding to the portion of the cell-to-cell connections meeting the predetermined criteria comprises:
assigning a weight to each cell-to-cell connection according to a complexity thereof; and
calculating an overall score of each cell-to-cell connection by multiplying a number of occurrences and a complexity of each cell-to-cell connection.

16. The system of claim 15, wherein the predetermined criteria indicate that the overall score of each cell-to-cell connection within the portion exceeds a predetermined threshold.

17. The system of claim 14, further comprising:
in response to the second netlist of the IC design failing to meet target goals, traversing cell-to-cell connection within the updated netlist.

18. The system of claim 17, wherein the one or more area reducing techniques comprise a transistor-sharing or common-node principle, complementary logic, logic expression optimization, implementing series and parallel sharing, pass transistor logic, or a combination thereof.

19. A method, comprising:
traversing, by a processor, a plurality of cell-to-cell connections within a first netlist of an integrated circuit (IC) design;
determining, by the processor, a plurality of candidate complex mega cells corresponding to a portion of the cell-to-cell connections meeting a predetermined criteria;
updating, by the processor, a cell library, which is used to generate the first netlist, with library files corresponding to the candidate complex mega cells;
synthesize, by the processor, the IC design using the updated cell library to obtain a second netlist of the IC design; and
performing, by the processor, an automatic placement-and-routing (APR) process on the second netlist using layout diagrams of the candidate complex mega cells.

20. The method of claim 19, wherein the updating, by the processor, the cell library, which is used to generate the first netlist, with the library files corresponding to the candidate complex mega cells comprises:
generating a hardware description language (HDL) source code file of each candidate complex mega cell;
synthesize the HDL source code file to generate a gate-level netlist of each candidate complex mega cell;
performing static timing analysis (STA) on the gate-level netlist of each candidate complex mega cell to generate a timing file of each candidate complex mega cell;
creating the library file corresponding to each candidate complex mega cell by adding cell information to the timing file of each candidate complex mega cell; and
updating the cell library by integrating the library files of the candidate complex mega cells into the cell library.
